(19) United States
(12) Patent Application Publication
(10) Pub. No.: US 2013/0173047 A1
(43) Pub. Date: Jul. 4, 2013

(54) Micro-machining Tool and Control System thereof

(71) Applicants: Yi-Hua Fan, Tao-Yuan (TW); Ching-En Chen, Tao-Yuan (TW); Wen-Wei Fan, Tao-Yuan (TW); Ying Tsun Lee, Tao-Yuan (TW)

(72) Inventors: Yi-Hua Fan, Tao-Yuan (TW); Ching-En Chen, Tao-Yuan (TW); Wen-Wei Fan, Tao-Yuan (TW); Ying Tsun Lee, Tao-Yuan (TW)

(73) Assignee: CHUNG YUAN CHRISTIAN UNIVERSITY, Tao-Yuan (TW)

(21) Appl. No.: 13/414,376

(22) Filed: Mar. 7, 2012

(30) Foreign Application Priority Data
Dec. 28, 2011 (TW) 100149308

(51) Int. Cl. G05B 19/19; F16M 13/00

(52) U.S. Cl. 700/193; 248/658; 700/186

(57) ABSTRACT

A micro-machining tool is disclosed herein. It includes a micro-moving platform, a supporting device to support the micro-moving platform, an anti-rotation device embedded in a bar for preventing the supporting device from rotating, and a fixing device for fixing the supporting device for limiting its rotation as the bar is moving.

### BACKGROUND OF THE INVENTION

1. Field of the Invention

The present invention relates to a micro-machining tool, and more particularly, to a micro-machining tool based on a pantograph and a control system thereof.

2. Description of the Prior Art

In light of the miniaturization trend of industrial products, the components of these miniaturized industrial products need to be more compact. In addition, they may not be made of silicon or silicon-based materials and have complex three-dimensional shapes, so micro-Electro-Mechanical systems (MEMS) are not always applicable. Non-MEMS micro-/nano-scale technologies will still remain the main methods for manufacturing components/products in this field.

In the aerospace industry, automotive industry, biomedical industry, optical industry, military industry and the microelectronics packaging industry, miniaturized devices with good aspect ratios and fine appearance are increasingly needed. Therefore, there is an imperative need to develop micro-/nano-scale machines to enable fast, direct, mass production of miniaturized products made of metals, polymers, composites or clay materials. For high-precision machine tools and mechanical and electrical integration, miniaturization and high performance are both important design consideration. High precision machining can significantly improve the quality and reliability of the products, while reducing the size and weight thereof, giving products a more competitive edge. As such, the industry demand for micro-components is increasing. As for the design considerations of the micro-machining tools, even higher precision is required.

However, according to the study of existing literature, micro-components are relatively expensive. S. M. Wang, C. P. Yang, Z. S. Chiang and J. S. Huang, “Development of a new low-cost and high-resolution micro machine tool”, The 2nd International Conference on Micro manufacturing, 2007, proposes a toggle-type design that regulates and controls movements to reduce displacement and achieve high precision. However, using this type of regulation requires a considerable amount of compensation measures to achieve the desired positioning precision.

In view of the shortcomings above, the present invention provides a micro-machining tool and a control system thereof, which reduces the cost of the micro-machining tool and the amount of compensation measures necessary for the traditional micro-machining tool control system.

### SUMMARY OF THE INVENTION

In view of the above background and special requirements of the industry, the present invention provides a pantograph that addresses the issues that are not yet solved in the prior art.

An objective of the present invention is to use a machine tool to drive a pantograph, and a micro-moving platform is provided at a reduced-scale end of the pantograph, thereby achieving micro-scale accuracy in movements.

Another objective of the present invention is to achieve required accuracy by adjusting scaling ratio of a pantograph.

Yet another objective of the present invention is to prevent a micro-moving platform of the present invention from rotating as a pantograph is moving by an anti-rotation device.

Still another objective of the present invention is to provide a micro-moving platform of the present invention with two axial components of displacements generated when a pantograph is moving by two rails.

The present invention discloses a micro-machining tool, which may include: a micro-moving platform; a supporting device for supporting the micro-moving platform; an anti-rotation device embedded in a bar for preventing the supporting device from rotating; and a fixing device for fixing the supporting device to limit its rotation as the bar is moving.

In the above micro-machining tool, the supporting device may further include a supporting axis.

In the above micro-machining tool, the anti-rotating device may further include a bearing that axially supports the supporting device.

In the above micro-machining tool, the bearing may include a ball bearing.

In the above micro-machining tool, the fixing device may further include: a clamp disposed underneath the supporting device for securing the supporting device; a first rail disposed underneath the clamp in a first axial direction; and a second rail disposed underneath the first rail in a second axial direction, wherein the first and second axial directions include perpendicular directions.

In the above micro-machining tool, the fixing device may further include a set screw for preventing the supporting device from rotating.

In the above micro-machining tool, the first and second rails may include at least a linear rail.

In the above micro-machining tool, when the bar is moving, the first and second rails respectively provide first and second axial components of displacements for the clamp, the supporting device and the micro-moving platform.

In the above micro-machining tool, the fixing device may further include: a first rail disposed underneath the micro-moving platform in a first axial direction; a second rail disposed underneath the first rail in a second axial direction, wherein the first and second axial directions include perpendicular directions; and a clamp disposed between the second rail and the supporting device for securing the supporting device, wherein the supporting device further supports the first and second rails and the clamp.

In the above micro-machining tool, the fixing device may further include a set screw for preventing the supporting device from rotating.

In the above micro-machining tool, the first and second rails may include at least a linear rail.

In the above micro-machining tool, when the bar is moving, the first and second rails respectively provide first and second axial components of displacements for the clamp, the supporting device and the micro-moving platform.

In the above micro-machining tool, the bar may further include a bar of a pantograph.

The above micro-machining tool may further include disposed on a proportionally-reduced-scale path of the pantograph.

The present invention also discloses a micro-machining tool control system, which may include: a proportional amplifier for receiving and amplifying at least a working path command signal and outputting the amplified signal; a three-axis machine tool for receiving the signal outputted by the proportional amplifier and driving a pantograph to move; and a micro-machining tool that is disposed on a proportionally-reduced-scale path of the pantograph and moves in proportionally reduced scale along with the movement of the pantograph, wherein the micro-machining tool may include: a micro-moving platform; a supporting axis for supporting the micro-moving platform; a bearing embedded in a bar of the pantograph for axially supporting the supporting axis and preventing the supporting axis from rotating as the bar of the pantograph is moving; and a fixing device for fixing the supporting axis to limit its rotation as the bar of the pantograph is moving.

The above micro-machining tool control system may further include two optical rulers for respectively detecting and feeding back displacements of the pantograph in a first axial direction and a second axial direction to the three-axis machine tool for adjusting displacement error of the pantograph.

The above micro-machining tool control system may further include two linear displacement optical rulers for respectively detecting displacements of the micro-machining tool in a first axial direction and a second axial direction and outputting corresponding displacement signals.

The above micro-machining tool control system may further include a compensation control system for receiving the corresponding displacement signals outputted by the two linear displacement optical rulers, and adjusting the at least one working path command signal that is outputted to the proportional amplifier.

In the above micro-machining tool control system, the fixing device may further include: a clamp disposed underneath the supporting axis for securing the supporting axis; a first rail disposed underneath the clamp in a third axial direction; and a second rail disposed underneath the first rail in a fourth axial direction, wherein the third and fourth axial directions include perpendicular directions.

In the above micro-machining tool control system, the fixing device may further include a set screw for preventing the supporting axis from rotating.

In the above micro-machining tool control system, the first and second rails may include at least a linear rail.

In the above micro-machining tool control system, when the bar of the pantograph is moving, the first and second rails respectively provide third and fourth axial components of displacements for the clamp, the supporting axis and the micro-moving platform.

In the above micro-machining tool control system, the fixing device may further include: a first rail disposed underneath the micro-moving platform in a third axial direction; a second rail disposed underneath the first rail in a fourth axial direction, wherein the third and fourth axial directions include perpendicular directions; and a clamp disposed between the second rail and the supporting axis for securing the supporting axis, wherein the supporting axis further supports the first and second rails and the clamp.

In the above micro-machining tool control system, the fixing device may further include a set screw for preventing the supporting device from rotating.

In the above micro-machining tool control system, the first and second rails may include at least a linear rail.

In the above micro-machining tool control system, wherein when the bar of the pantograph is moving, the first and second rails respectively provide third and fourth axial components of displacements for the clamp, the supporting axis and the micro-moving platform.

### BRIEF DESCRIPTION OF THE DRAWINGS

FIG. 1 is a traditional pantograph;

FIG. 2A is a schematic diagram depicting the relative positions of a preferred embodiment of the present invention and a pantograph;

FIG. 2B is a schematic diagram depicting the relative positions of another preferred embodiment of the present invention and another pantograph;

FIG. 3A is a block diagram depicting a preferred embodiment of the present invention;

FIG. 3B is a preferred structural diagram of FIG. 3A;

FIG. 4A is a block diagram depicting another preferred embodiment of the present invention;

FIG. 4B is a preferred structural diagram of FIG. 4A;

FIG. 5A is an open-loop control system embodiment for a micro-machining tool of the present invention;

FIG. 5B is a preferred closed-loop control system embodiment for a micro-machining tool of the present invention;

FIG. 6A is a graph showing test results for simulating linear movement at a driving end in an embodiment of the present invention;

FIG. 6B is a graph showing test results for simulating linear movement at a reduced-scale end in an embodiment of the present invention;

FIG. 7A is a graph showing test results for simulating circular movement at a driving end in an embodiment of the present invention;

FIG. 7B is a graph showing test results for simulating circular movement at a reduced-scale end in an embodiment of the present invention;

FIG. 8A is a graph showing test results for simulating oval movement at a driving end in an embodiment of the present invention;

FIG. 8B is a graph showing test results for simulating oval movement at a reduced-scale end in an embodiment of the present invention;

FIG. 9A is a graph showing results (including theoretical and actual movement values) measured when the control system shown in FIG. 5A moves linearly in both axes in an embodiment of the present invention;

FIG. 9B is a diagram showing results (including theoretical and actual movement values) measured when the control system shown in FIG. 5A moves in a circle in both axes in an embodiment of the present invention;

FIG. 10A is a graph showing results (including theoretical and actual movement values) measured when the control system shown in FIG. 5B moves linearly in both axes in an embodiment of the present invention; and

FIG. 10B is a diagram showing results (including theoretical and actual movement values) measured when the control system shown in FIG. 5B moves in a circle in both axes in an embodiment of the present invention.

### DETAILED DESCRIPTION OF THE PREFERRED EMBODIMENTS

The present invention is directed to pantographs. In order to facilitate understanding of the present invention, detailed structures and their elements and method steps are set forth in the following descriptions. Obviously, the implementations of the present invention are not limited to specific details known to those skilled in the art of pantographs. On the other hand, well-known structures and their elements are omitted herein to avoid unnecessary limitations on the present invention. In addition, for better understanding and clarity of the description by those skilled in the art, some components in the drawings may not necessary be drawn to scale, in which some may be exaggerated relative to others, and irrelevant parts are omitted. Preferred embodiments of the present invention are described in details below, in addition to these descriptions, the present invention can be widely applicable to other embodiments, and the scope of the present invention is not limited by such, rather by the scope of the following claims.

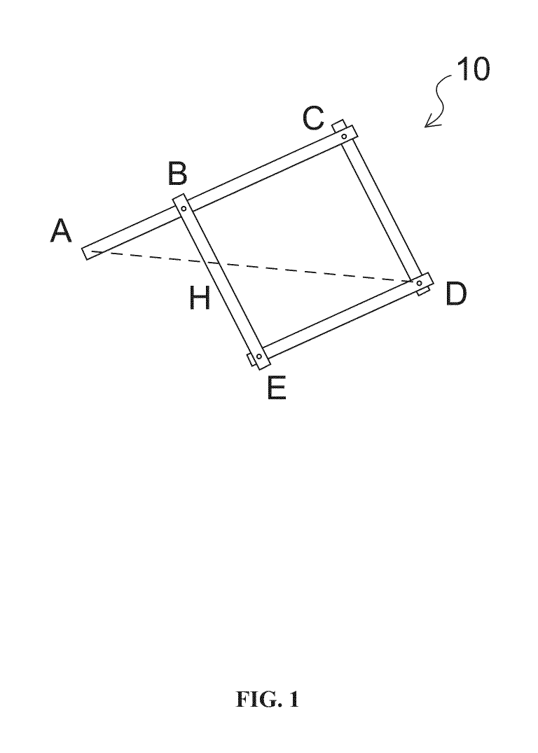

Referring to FIG. 1, a traditional pantograph 10 is shown. The pantograph 10 has four bars AC, CD, DE and EB, wherein the length of bar AC is larger than that of bars CD, DE and EB. The four bars are connected at four nodes B, C, D and E, forming a parallelogram. In an embodiment of the present invention, node D is a fixed end while node A is a driving end. The distance displaced by node A will be proportionally reduced for a distance displaced by a node on a straight-line path formed by nodes A and D. Take node H for example, node H is a point on bar EB and is on the straight-line path formed by nodes A and D, thus two triangles ACD and ABH are similar triangles, and the ratio of the distance displaced by node A to the distance displaced by node H would be the ratio of straight line AD to straight line DH. In other words, the distance displaced by node H reduces the distance displaced by node A by (straight line DH)/(straight line AD). Thus, in the present invention, the straight-line path formed by nodes A and D is a so-called “proportionally-reduced-scale path”. Moreover, in an embodiment of the present invention, pitch BC=pitch DE>pitch CD=pitch EB; in another embodiment of the present invention, pitch BC=pitch DE<pitch CD=pitch EB; and in yet another embodiment of the present invention, pitch BC=pitch DE=pitch CD=pitch EB.

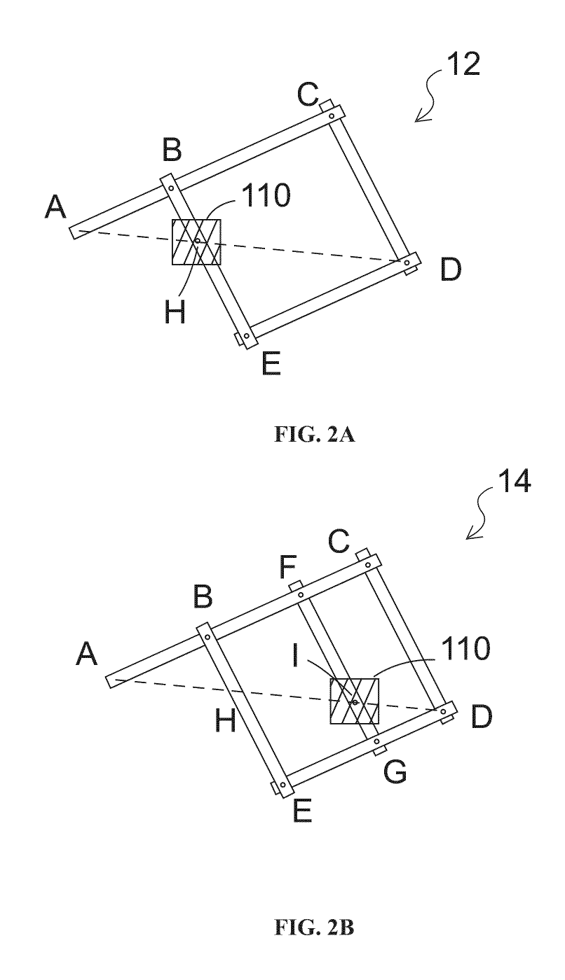

Referring to FIG. 2A, a schematic diagram depicting the relative positions of a preferred embodiment 12 of the present invention and a pantograph is shown. A micro-machining tool 110 is disposed at node H of bar EB of the pantograph, which is on the proportionally-reduced-scale path of a straight line formed by nodes A and D. Thus, the displacement of the micro-machining tool 110 reduces the distance displaced by node A by (straight line DH)/(straight line AD). Referring now to FIG. 2B, a schematic diagram depicting the relative positions of another preferred embodiment 14 of the present invention and another pantograph is shown. A micro-machining tool 110 is disposed at node I of bar FG of the pantograph, which is on the proportionally-reduced-scale path of a straight line formed by nodes A and D. Thus, the displacement of the micro-machining tool 110 reduces the distance displaced by node A by (straight line DI)/(straight line AD).

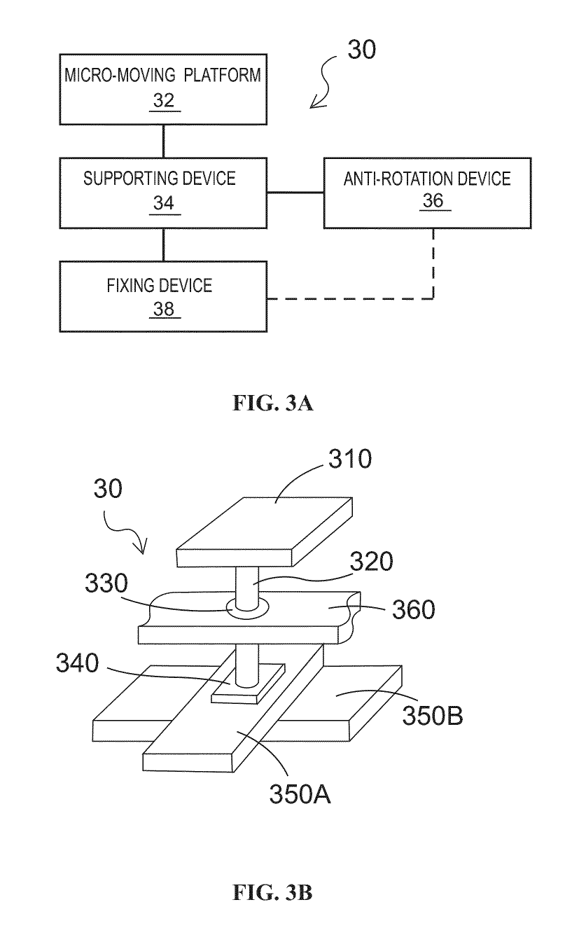

Referring to FIG. 3A, a block diagram depicting a preferred embodiment 30 of the present invention is shown. The preferred embodiment 30 includes a micro-moving platform 32; a supporting device 34 for supporting the micro-moving platform 32, wherein the supporting device 34 includes a supporting axis; an anti-rotation device 36 embedded in a bar for preventing the supporting device 34 from rotating, wherein the anti-rotating device 36 includes a bearing that axially supports the supporting device 34, and the above bar is a bar of a pantograph; and a fixing device 38 for fixing the supporting device 34 to limit its rotation as the bar is moving.

In this embodiment, the bearing includes a ball bearing. Referring now to FIG. 3B, a preferred structural diagram of FIG. 3A is shown. It includes a micro-moving platform 310; a supporting axis 320 located below the micro-moving platform 310 for supporting the micro-moving platform 310; a bearing 330 embedded in a bar 360 of a pantograph for axially supporting the supporting axis 320 and preventing the supporting axis 320 from rotating as the bar 360 of the pantograph is moving; a clamp 340 located below the supporting axis 320 for fixing the supporting axis 320 and preventing the supporting axis 320 from rotating as the bar 360 of the pantograph is moving; a first rail 350A located underneath the clamp 340 in a first axial direction; and a second rail 350B located underneath the first rail 350A in a second axial direction, wherein the first and second axial directions include perpendicular directions.

In this embodiment, the fixing device 38 further includes a set screw for preventing the supporting device 34 from rotating, but the present invention is not limited to this. The first and second rails 350A and 350B include linear rails, and when the bar 360 of the pantograph is moving, the first and second rails 350A and 350B provide first and second axial components of displacements for the clamp 340, the supporting axis 320 and the micro-moving platform 310. Moreover, this embodiment is on the proportionally-reduced-scale path of the pantograph.

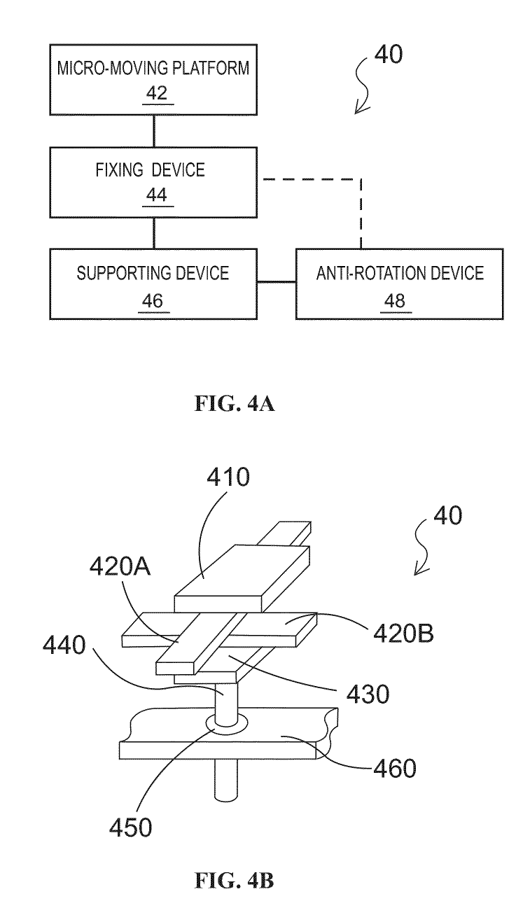

Referring to FIG. 4A, a block diagram depicting another preferred embodiment 40 in this invention is shown. The preferred embodiment 40 includes a micro-moving platform 42; a supporting device 46 for supporting the micro-moving platform 42, wherein the supporting device 46 includes a supporting axis; an anti-rotation device 48 embedded in a bar for preventing the supporting device 46 from rotating, wherein the anti-rotating device 48 includes a bearing that axially supports the supporting device 46, and the above bar is a bar of a pantograph; and a fixing device 44 for fixing the supporting device 46 to limit its rotation as the bar is moving. This embodiment is different from that of FIG. 3A in that the supporting device 46 of this embodiment further supports the fixing device 44. In other words, the relative positions of the fixing device 44 and the supporting device 46 of this embodiment are different from the relative positions of the fixing device 38 and the supporting device 34 of FIG. 3A.

Moreover, in this embodiment, the bearing includes a ball bearing. Referring now to FIG. 4B, a preferred structural diagram of FIG. 4A is shown. It includes a micro-moving platform 410; a first rail 420A located underneath the micro-moving platform 410 in a first axial direction; a second rail 420B located underneath the first rail 420A in a second axial direction, wherein the first and second axial directions include perpendicular directions; a clamp 430 located below the second rail 420B; a supporting axis 440 located below the clamp 430 for supporting the micro-moving platform 410, the first and second rails 420A and 420B and the clamp 430, wherein the clamp 430 is further used for fixing the supporting axis 440 and preventing the supporting axis 440 from rotating as a bar 460 of a pantograph is moving; and a bearing 450 embedded in the bar 460 of the pantograph for axially supporting the supporting axis 440 and preventing the supporting axis 440 from rotating as the bar 460 of the pantograph is moving.

In this embodiment, the fixing device 44 further includes a set screw for preventing the supporting device 46 from rotating, but the present invention is not limited to this. The first and second rails 420A and 420B include linear rails, and when the bar 460 of the pantograph is moving, the first and second rails 420A and 420B provide first and second axial components of displacements for micro-moving platform 410, the clamp 340, and the supporting axis 440. Moreover, this embodiment is on the proportionally-reduced-scale path of the pantograph. It should be noted that, if the architecture of FIG. 4A and/or structure of FIG. 4B are adopted, a supplementary supporting device is required for securing the fixing device to prevent the fixing device from losing its balance when the micro-moving platform excessively moves in a certain axial direction. This part is apparent to those skilled in the art in light of the disclosure herein, and will therefore not be further described.

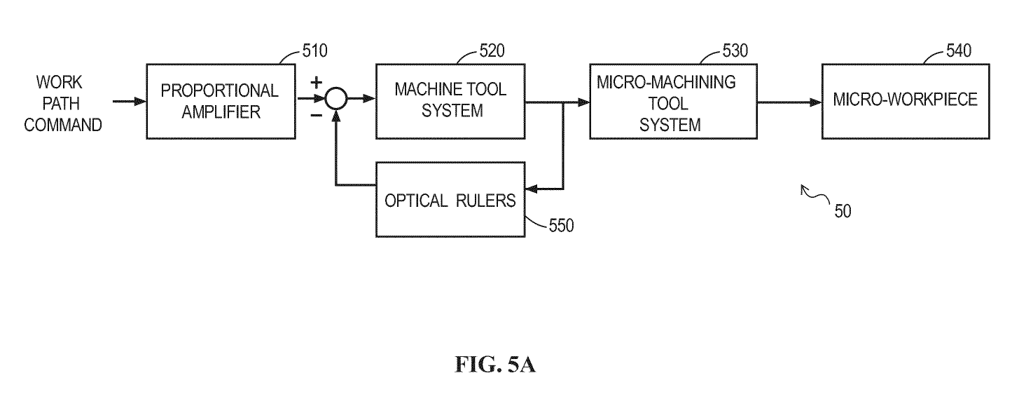

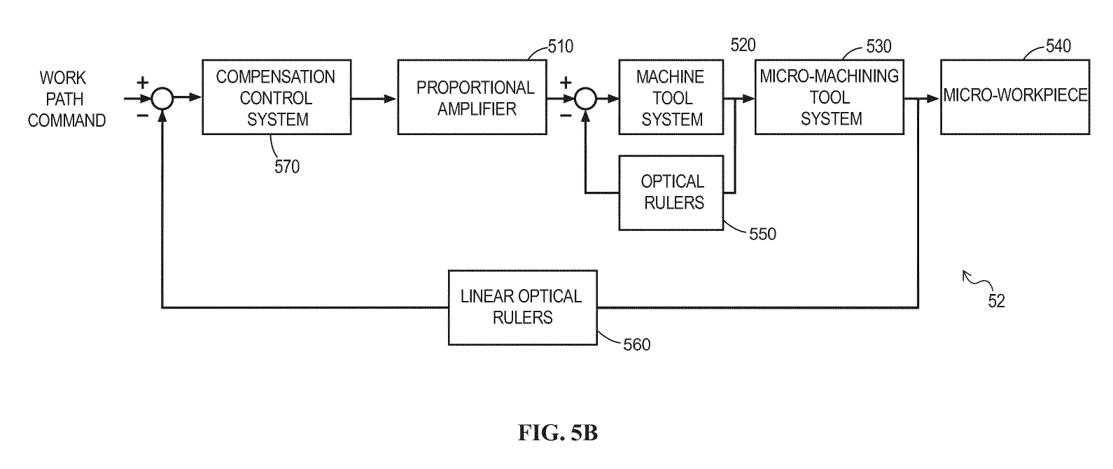

Referring to FIG. 5A, an open-loop control system embodiment 50 for a micro-machining tool of the present invention is shown. It includes a proportional amplifier 510 for receiving and amplifying at least a working path command signal and outputting the amplified signal; a machine tool system 520 (e.g. a three-axis machine tool) for receiving the signal outputted by the proportional amplifier 510 and driving a pantograph to move; a micro-machining tool system 530 (e.g. the micro-machining tool shown in FIGS. 3A and 3B and/or FIGS. 4A and 4B, which will not be described further) that is disposed on the proportionally-reduced-scale path of the pantograph and moves in proportionally reduced scale along with the movement of the pantograph; a micro-workpiece 540 provided on the micro-machining tool system 530 and to be machined. This micro-machining tool control system 50 further includes two optical rulers 550 for respectively detecting and feeding back displacements of the pantograph in a first axial direction and a second axial direction to the machine tool system 520 (e.g. a three-axis machine tool), such that the displacement error of the pantograph is adjusted.

Referring to FIG. 5B, a preferred closed-loop control system embodiment 52 for a micro-machining tool of the present invention is shown. The embodiment of FIG. 5B is different from that of FIG. 5A in that it further includes two linear displacement optical rulers 560 and a compensation control system 570. The two linear displacement optical rulers 560 respectively detect displacements of the micro-machining tool system 530 in a first axial direction and a second axial direction and output corresponding displacement signals. The compensation control system 570 receives the corresponding displacement signals outputted by the two linear displacement optical rulers 560, and adjusts the at least one working path command signal that is outputted to the proportional amplifier 510. As for the relative relationships and functions of the proportional amplifier 510, the machine tool system 520, the micro-machining tool system 530, the micro-workpiece 540 and the two optical rulers 550 are the same as those described with respect to FIG. 5A, and thus will not be repeated.

It should be noted that the first and second rails in the embodiment shown in FIGS. 5A and/or 5B are disposed in a third axial direction and a fourth axial direction, respectively, wherein the third and fourth axial directions include perpendicular directions. Thus, when the bar of the pantograph is moving, the first and second rails respectively provide third and fourth axial components of displacements for the clamps, the supporting axis and the micro-moving platform, and the third and fourth axial directions may include corresponding to the first and second axial directions.

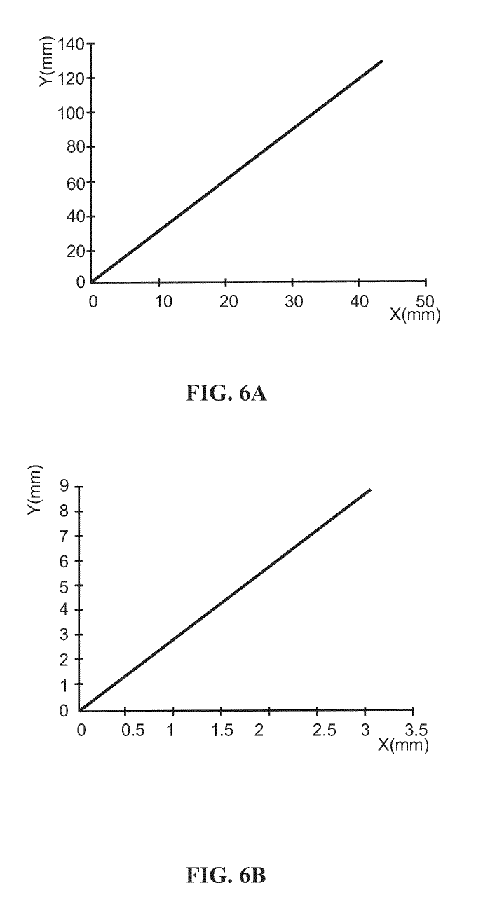

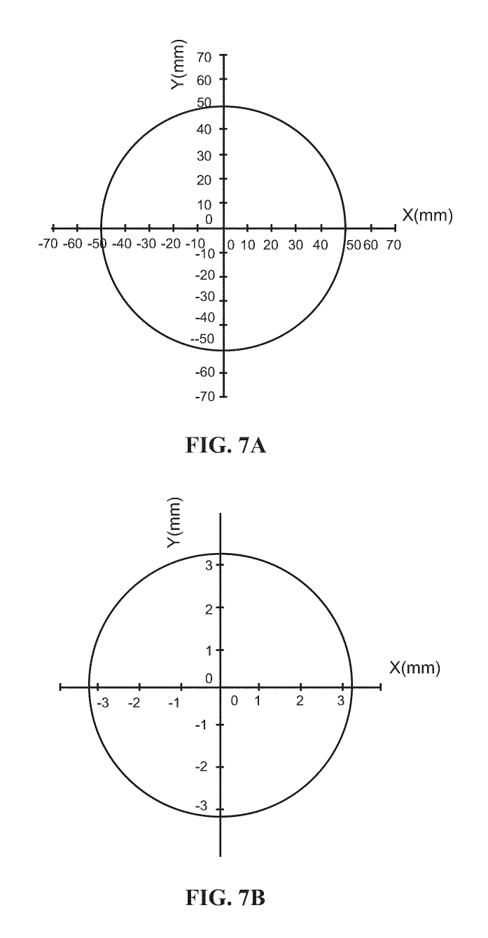

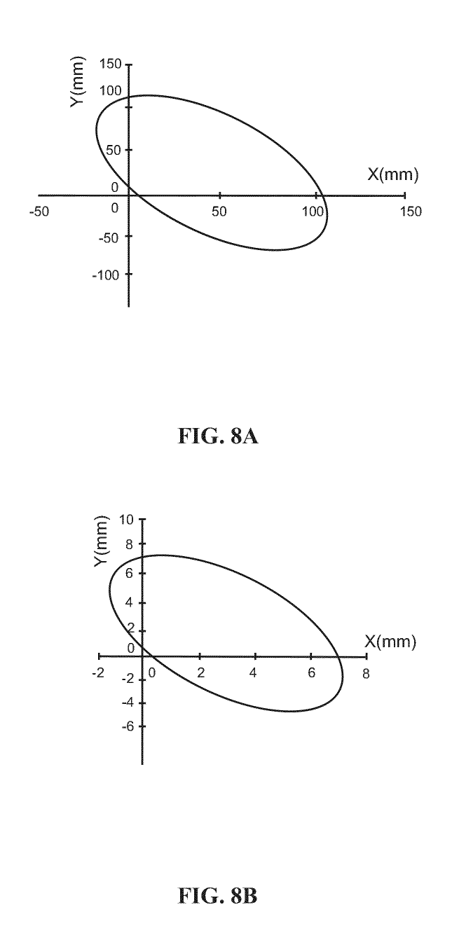

Referring now to FIGS. 6A, 6B, 7A, 7B, 8A and 8B, test results for simulating linear movement, circular movement and oval movement at a driving end and a reduced-scale end (where the micro-machining tool is located) in Solidworks in an embodiment of the present invention are shown, respectively. It should be noted that data set for simulations and data obtained from tests are merely illustrative of a testing process of the embodiment of the present invention and results thereof; the implementations of the embodiments of the present invention are not limited to these. According to the simulation results shown in FIGS. 6A, 6B, 7A, 7B, 8A and 8B, the reduction ratio of this embodiment is approximately 1/16, and the movement paths of the driving and reduced-scale ends are similar. In other words, the displacement at the reduced-scale end in this embodiment proportionally reduces the displacement at the driving end.

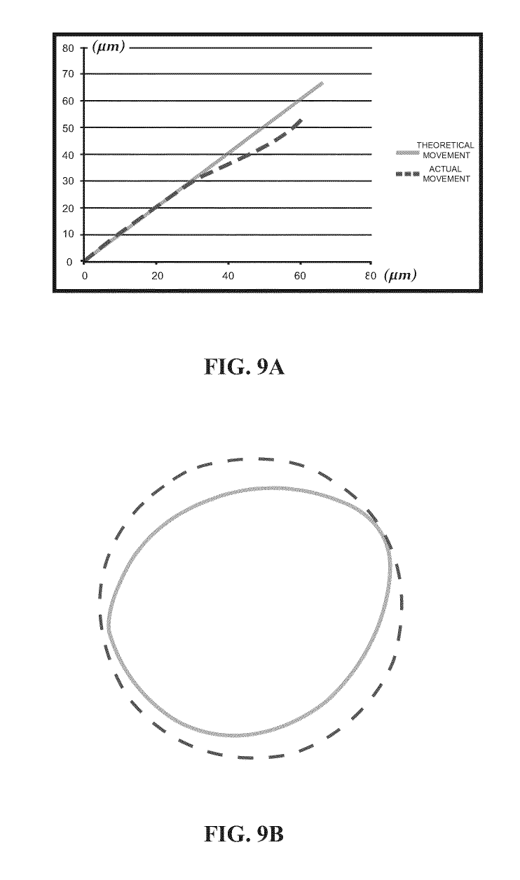

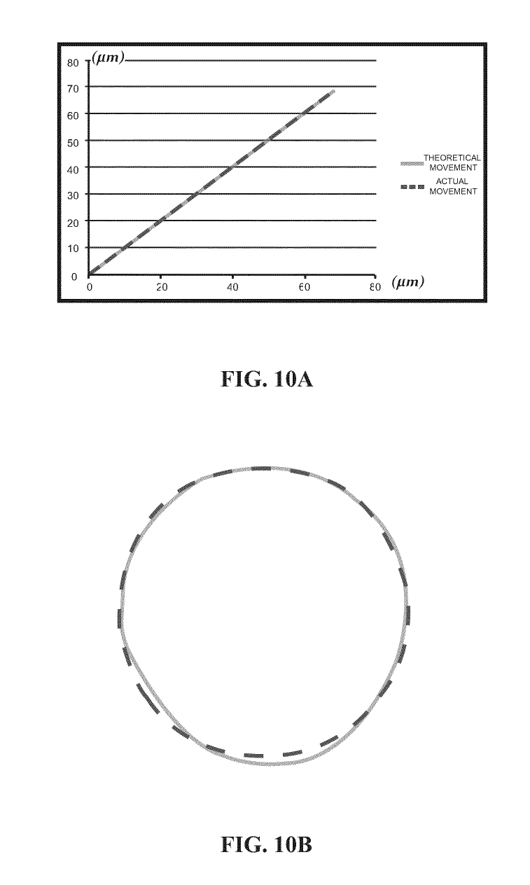

Referring now to FIGS. 9A, 9B, 10A and 10B, results (including theoretical and actual movement values) measured when the control systems shown in FIGS. 5A and 5B move in both of the two axes are shown, respectively. Referring first to FIG. 9A, in a case of a path is set to move forward in a 45 degree angle (i.e. moves along the two axes with equal distances) and the driving end is set to feed to 1 mm, the further the feed distance, the more the difference between the theoretical and actual displacements.

Referring now to FIG. 9B, when a circle with a diameter of 1 mm is used for driving the driving end, the error in radius between the actual and theoretical circular trajectories is between −0.3%-25.25%. Referring to FIG. 10A, in which the same test conditions as those of FIG. 9A are set forth but the control system shown in FIG. 5B is used for compensation, and the maximum contour error between the actual and theoretical movement values is about 7.071×10⁻³. Furthermore, in terms of comparison of linear displacements, the overall accuracy is increased by about 72%, and the differences between the theoretical and actual displacements are compensated at longer feed distances.

Referring to FIG. 10B, in which the same test conditions as those of FIG. 9A are used, but the control system shown in FIG. 5B is used for compensation, the error in radius between the actual and theoretical circular trajectories is between −6.2%-6.15%, and the overall accuracy is increased by about 48%.

It is apparent that based on the above descriptions of the embodiments, the present invention can have numerous modifications and alterations, and they should be construed within the scope of the following claims. In addition to the above detailed descriptions, the present invention can be widely applied to other embodiments. The above embodiments are merely preferred embodiments of the present invention, and should not be used to limit the present invention in any way. Equivalent modifications or changes can be made by those with ordinary skill in the art without departing from the scope of the present invention as defined in the following appended claims.

What is claimed is:

1. A micro-machining tool comprising:
a micro-moving platform;
a supporting device for supporting the micro-moving platform;
an anti-rotation device embedded in a bar for preventing the supporting device from rotating; and
a fixing device for fixing the supporting device to limit its rotation as the bar is moving.

2. The micro-machining tool of claim 1, wherein the supporting device further includes a supporting axis.

3. The micro-machining tool of claim 1, wherein the anti-rotating device further includes a bearing that axially supports the supporting device.

4. The micro-machining tool of claim 1, wherein the bearing includes a ball bearing.

5. The micro-machining tool of claim 1, wherein the fixing device further includes:
a clamp disposed underneath the supporting device for securing the supporting device;
a first rail disposed underneath the clamp in a first axial direction; and
a second rail disposed underneath the first rail in a second axial direction, wherein the first and second axial directions include perpendicular directions.

6. The micro-machining tool of claim 5, wherein the fixing device further includes a set screw for preventing the supporting device from rotating.

7. The micro-machining tool of claim 5, wherein the first and second rails include at least a linear rail.

8. The micro-machining tool of claim 5, wherein when the bar is moving, the first and second rails respectively provide first and second axial components of displacements for the clamp, the supporting device and the micro-moving platform.

9. The micro-machining tool of claim 1, wherein the fixing device further includes:
a first rail disposed underneath the micro-moving platform in a first axial direction;
a second rail disposed underneath the first rail in a second axial direction, wherein the first and second axial directions include perpendicular directions; and
a clamp disposed between the second rail and the supporting device for securing the supporting device, wherein the supporting device further supports the first and second rails and the clamp.

10. The micro-machining tool of claim 9, wherein the fixing device further includes a set screw for preventing the supporting device from rotating.

11. The micro-machining tool of claim 9, wherein the first and second rails include at least a linear rail.

12. The micro-machining tool of claim 9, wherein when the bar is moving, the first and second rails respectively provide first and second axial components of displacements for the clamp, the supporting device and the micro-moving platform.

13. The micro-machining tool of claim 1, wherein the bar further includes a bar of a pantograph.

14. The micro-machining tool of claim 13, further comprising disposed on a proportionally-reduced-scale path of the pantograph.

15. A micro-machining tool control system comprising:
a proportional amplifier for receiving and amplifying at least a working path command signal and outputting the amplified signal;
a three-axis machine tool for receiving the signal outputted by the proportional amplifier and driving a pantograph to move; and
a micro-machining tool that is disposed on a proportionally-reduced-scale path of the pantograph and moves in proportionally reduced scale along with the movement of the pantograph, wherein the micro-machining tool includes:
a micro-moving platform;
a supporting axis for supporting the micro-moving platform;
a bearing embedded in a bar of the pantograph for axially supporting the supporting axis and preventing the supporting axis from rotating as the bar of the pantograph is moving; and
a fixing device for fixing the supporting axis to limit its rotation as the bar of the pantograph is moving.

16. The micro-machining tool control system of claim 15, further comprising two optical rulers for respectively detecting and feeding back displacements of the pantograph in a first axial direction and a second axial direction to the three-axis machine tool for adjusting displacement error of the pantograph.

17. The micro-machining tool control system of claim 15, further comprising two linear displacement optical rulers for respectively detecting displacements of the micro-machining tool in a first axial direction and a second axial direction and outputting corresponding displacement signals.

18. The micro-machining tool control system of claim 17, further comprising a compensation control system for receiving the corresponding displacement signals outputted by the two linear displacement optical rulers, and adjusting the at least one working path command signal that is outputted to the proportional amplifier.

19. The micro-machining tool control system of claim 15, wherein the fixing device further includes:
a clamp disposed underneath the supporting axis for securing the supporting axis;
a first rail disposed underneath the clamp in a third axial direction; and
a second rail disposed underneath the first rail in a fourth axial direction, wherein the third and fourth axial directions include perpendicular directions.

20. The micro-machining tool control system of claim 19, wherein the fixing device further includes a set screw for preventing the supporting axis from rotating.

21. The micro-machining tool control system of claim 19, wherein the first and second rails include at least a linear rail.

22. The micro-machining tool control system of claim 19, wherein when the bar of the pantograph is moving, the first and second rails respectively provide third and fourth axial components of displacements for the clamp, the supporting axis and the micro-moving platform.

23. The micro-machining tool control system of claim 15, wherein the fixing device further includes:
a first rail disposed underneath the micro-moving platform in a third axial direction;
a second rail disposed underneath the first rail in a fourth axial direction, wherein the third and fourth axial directions include perpendicular directions; and
a clamp disposed between the second rail and the supporting axis for securing the supporting axis, wherein the supporting axis further supports the first and second rails and the clamp.

24. The micro-machining tool control system of claim 23, wherein the fixing device further includes a set screw for preventing the supporting device from rotating.

25. The micro-machining tool control system of claim 23, wherein the first and second rails include at least a linear rail.

26. The micro-machining tool control system of claim 23, wherein when the bar of the pantograph is moving, the first and second rails respectively provide third and fourth axial components of displacements for the clamp, the supporting axis and the micro-moving platform.
